(19) United States
(12) Patent Application Publication
(10) Pub. No.: US 2013/0046935 A1
(43) Pub. Date: Feb. 21, 2013

(54) SHARED COPY CACHE ACROSS NETWORKED DEVICES

(71) Applicant: Rajesh Ramanathan, Redmond, WA (US)

(72) Inventor: Rajesh Ramanathan, Redmond, WA (US)

(73) Assignee: MICROSOFT CORPORATION, Redmond, WA (US)

(21) Appl. No.: 13/212,408

(22) Filed: Aug. 18, 2011

(51) Int. Cl. G06F 12/08

(52) U.S. Cl. 711/119; 711/E12.038; 711/E12.025

(57) ABSTRACT

A copy cache feature that can be shared across networked devices is provided. Content added to copy cache through a “copy”, a “like”, or similar command through one device may be forwarded to a server providing cloud-based services to a user and/or another device associated with the user such that the content can be inserted into the same or other files on other computing devices by the user. In addition to seamless movement of copy cache content across devices, the content may be made available in a context-based manner and/or sortable manner.

### BACKGROUND

With the proliferation of computing and networking technologies a wide variety of computing devices are utilized for daily tasks executing a large number of applications. Users typically use more than one computing device in their daily lives. A person may start the day using their laptop computer at home, continue their tasks with their desktop computer at work, and utilize a mobile computing device such as a smart phone throughout the day. The use of these devices may include in many cases generation and/or editing of documents or other files with various content through different applications. For example, a user may create a document on their laptop, access and edit the same document through their mobile device and/or their desktop computer adding, removing, and modifying content along the way.

One of the useful features of modern computing systems is a copy cache, also referred to as clipboard. Copy cache is used to store, in some case temporarily, content employing a copy command (through a keyboard button, mouse click, gesture, or similar simple action). The “copied” content may be stored in a volatile memory of the computing device and be lost when the computing device is powered down, or it may be stored in a file and be accessible even after a power reset. The “copied” content may be “pasted” or inserted into a file using another simple command (e.g., paste command). In conventional systems, whether stored in volatile memory or non-volatile memory, copy cache content is limited to the computing device on which the “copy” command is used. Thus, the copy cache feature is useless in multi-device use scenarios described above.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a copy cache feature that can be shared across networked devices. According to some embodiments, content added to copy cache through a “copy”, a “like”, or similar command through one device may be forwarded to a server providing cloud-based services to a user and/or another device associated with the user such that the content may be inserted into the same or other files on other computing devices by the user. In addition to seamless movement of copy cache content across devices, the content may be made available in a context-based manner and/or sortable manner.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example networked system for sharing copy cache according to some embodiments;

FIG. 2 illustrates another example networked system for sharing copy cache according other embodiments;

FIG. 3 illustrates an example user interface enabling a user to paste content from a shared copy cache;

FIG. 4 illustrates another example user interface for enabling a user to add content to a shared copy cache according to embodiments;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of sharing copy cache across networked devices according to embodiments.

### DETAILED DESCRIPTION

As briefly described above, a shared copy cache that is available to users across various devices may be capable of understanding the user context to suggest various content that the user may have tagged, copied, or added to the copy cache on another device. In the following detailed description, references are made to the accompanying drawings that form a part hereof, and in which are shown by way of illustrating specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a non-transitory computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for providing networked access to a plurality of computing devices with copying/pasting or similar functionality. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

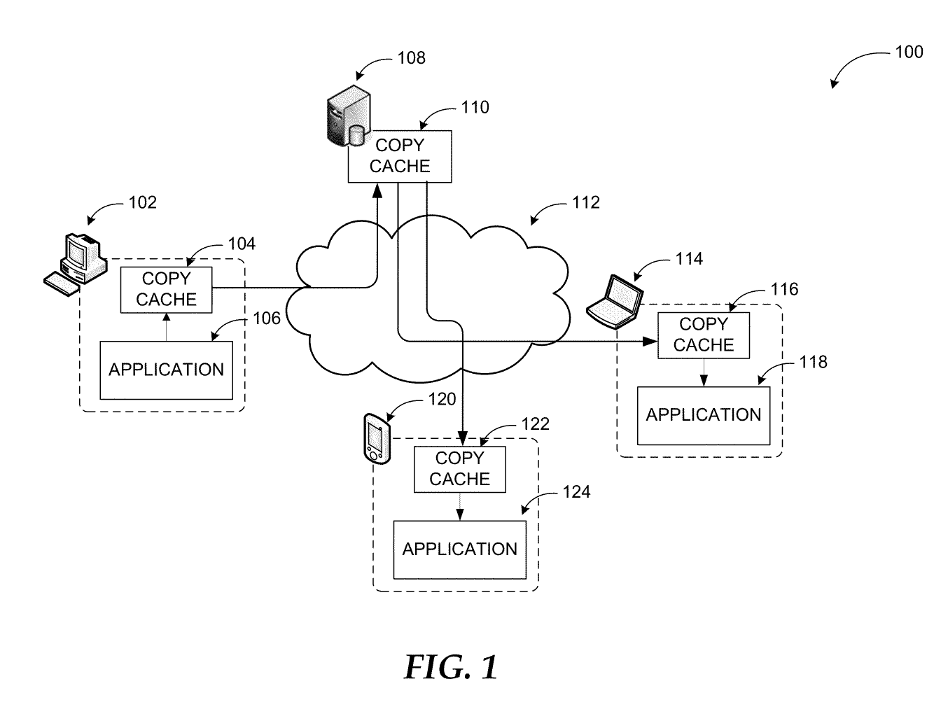

Referring to FIG. 1, diagram 100 illustrates an example networked system for sharing copy cache according to some embodiments. Example components shown in diagram 100 are for illustration purposes. Embodiments may be implemented in various local, networked, and similar computing environments employing a variety of computing devices and systems.

According to some embodiments, a shared copy cache can roam across a variety of devices associated with a user such as a desktop computer, a mobile computer, a vehicle mount computer, a wearable computer, and similar devices without having to manually move information across these devices. Thus, “seamless” access to copy cache content is provided from any application on any device associated with the user. In providing shared copy cache content, locality and/or chronology of information may be preserved allowing ordering and presentation of information from such a shared copy cache that would make sense to the user in the current editing context. According to some embodiments, automatic association may be provided allowing the data from the copy cache to be automatically added to the respective repositories (e.g., a picture of a contact or a notice board automatically getting translated and added to the source). According to other embodiments, an enhanced copy cache mechanism may employ lazy translation to gather more information about the copied information before it is pasted in another machine.

Diagram 100 illustrates an example networked system, where content may be “copied” or similarly stored in copy cache 104 through an application 106 executed on desktop computer 102. Copy cache 104 may be a volatile or non-volatile storage in desktop computer 102 such as a Random Access Memory (RAM) or a specially created (temporary or permanent) file. Copy cache 104 may already have other content stored or it may be configured to store one new portion of content at a time. In addition to storing the new content in response to a user action such as a “copy” or similar command, the content may also be added automatically as discussed below. Upon addition of the new content, it may be shared with a copy cache 110 at server 108 that facilitates sharing of copy cache across devices associated with the user. The sharing of the new content with the copy cache 110 of server 108 may be in response to the addition of the new content at desktop computer 102, a user action (e.g., initiating a “share” process, or based on a periodic check by the server.

Server 108 may communicate with other computing devices associated with the user such as laptop computer 114 or mobile device 120 (e.g., a smart phone) over one or more networks 112. Server 108 may push copy cache data from copy cache 110 to copy caches 116 and 122 on laptop computer 114 and mobile device 120, respectively. The data may be pushed periodically or in response to receiving new content from any one of the devices associated with the user. In response to receiving new content from server 108, laptop computer 114 and mobile device 120 may enable respective applications 118 and 124 to make the new content available to the user through their copy cache user interfaces (e.g., a “paste” user interface). Applications 118 and 124 may be any application that enables creation or editing of content (textual, graphical, audio, video, etc.) and may present available copy cache content in a sorted manner (e.g., based on capture time, source location, source device, size, type, etc.). According to other embodiments, the copy cache content may be presented in a contextual manner. For example, textual copy cache content may be presented with high priority if the user is creating or editing a text document as opposed to audio or video content.

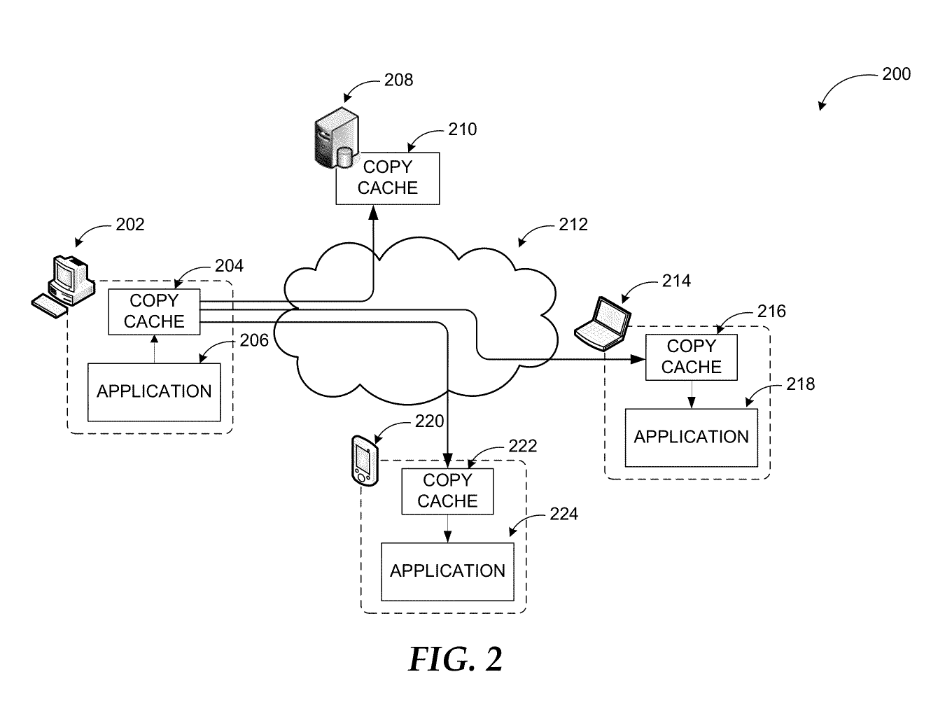

FIG. 2 illustrates another example networked system for sharing copy cache according other embodiments. The example system in diagram 200 operates in a similar manner to the system of FIG. 1. Thus, new content may be added to copy cache 204 in desktop computer 202 through application 206 and shared with copy caches 210, 216, and 222 in server 208, laptop computer 214, and mobile device 220 with the latter two providing cached content to applications 218 and 224, respectively. Of course, new content may be captured through any of the devices associated with the user and shared with the remaining devices.

Desktop computer 202, laptop computer 214, and mobile device 220 may be in communication over one or more wired or wireless networks 212. Differently, from the example configuration in FIG. 1, in diagram 200, new content in copy cache 204 may be forwarded to copy cache 216 of laptop computer 214 and copy cache 222 of mobile device 220 directly as opposed to via server 208. Server 208 may still facilitate tasks associated with the sharing such as providing metadata information, maintaining a central shared copy cache in case one or more of the devices should need to synchronize its copy cache with the others, etc. In other embodiments, the system may be truly distributed and server 208 may not play a role at all.

As discussed above, embodiments are directed to allowing the data from the shared copy cache to be automatically added to the respective repositories (e.g., picture of a contact or a notice board may automatically get translated and added to the source). If a user copies an image, for example, then finding that image along with their other pictures in a “pictures” storage in the computer may allow them to find the image quicker. Thus, the “pictures” storage may have a folder for the shared copy cache that contains the copied images. A similar mechanism may be employed for documents, audio files, video files, etc.

An enhanced shared copy cache according to some embodiments may use lazy translation to gather more information about the copied data before it is pasted in another machine. This may allow a user to select more suitable destinations and enhance the search so they can find more related items when they use a browser, etc. For example, a user may be browsing an internet site and copy an address from it. That address can be stored in the shared copy cache and translated to a business name. When they start pasting the address in the destination device, the user may also get additional option to paste the business logo, as well as the phone numbers. In a way, copying any information may trigger a backend search that aggregates more information and surfaces it when the paste activity is in progress. The purpose of the search may be to also obtain appropriate attributes such as a name, a map, a location (when an address is copied, for example), or the name and logo of a business. The complementary information resulting from the search may enhance a user experience by enriching the copied information. In some embodiments, the backend search may be a contextual search that matches a most likely match.

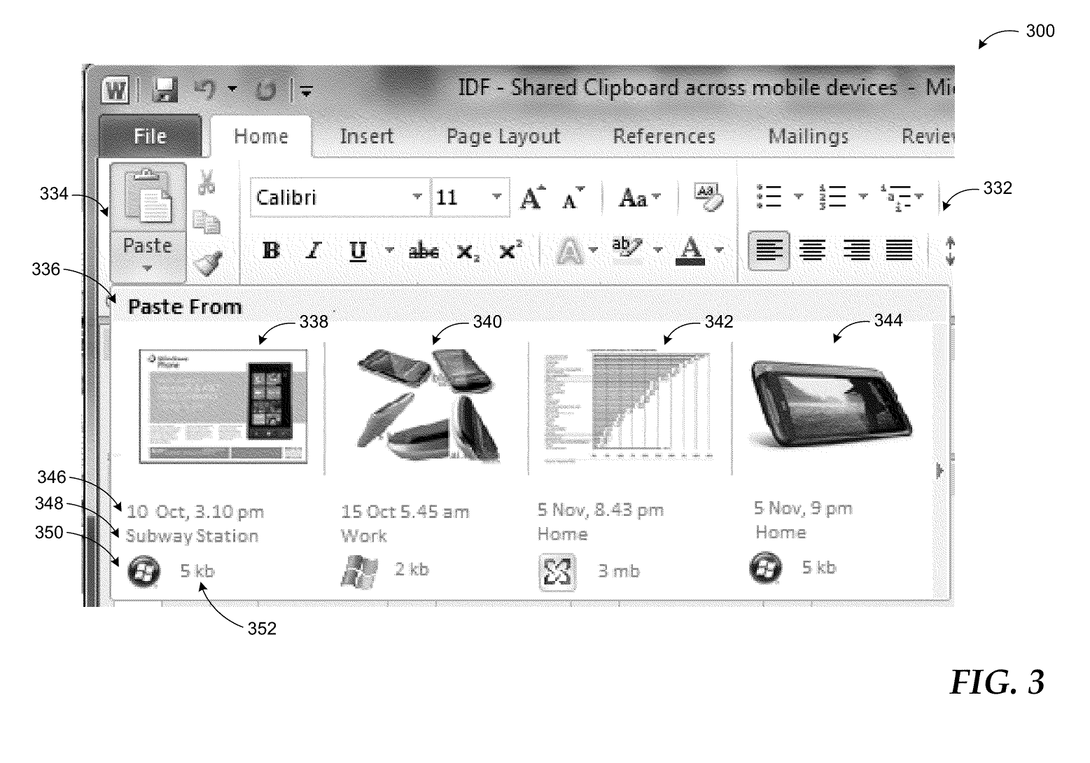

FIG. 3 illustrates an example user interface enabling a user to paste content from a shared copy cache. New content may be captured for and retrieved from copy cache through any application user interface. Adding new content and retrieving may be accomplished through commands represented textually or graphically in the application's regular user interface. In some embodiments, a user interface for copy cache functionality may be presented. For example, available content may be presented using a textual and/or graphical scheme when a copy or paste command is selected. Other forms of interaction such as voice commands or gesture recognition may also be used to take advantage of copy cache functionality.

The example screenshot 300 in FIG. 3 illustrates an example user interface for a word processing, spreadsheet, presentation, or graphics application. As mentioned above, other types of applications may also employ similar shared copy cache functionality. The user interface in example screenshot 300 includes a command menu 332, where various commands are presented textually and graphically. One example command is “paste” 334. In response to activation of “paste” 334, a sub-menu 336 may be presented, where available shared copy cache content is displayed in a sorted manner.

Each presented available content may also include additional information such as date and time of capture 346, location of capture 348, an application (or operating system) through which the content was captured (350), and a size 352 of the content. The content may carry with it these aspects of the source location and storage, and the date and time it was captured, along with information on the location it was captured in. Such information may be made available later in any other application on a different computing device.

Graphical representations of each available content 338, 340, 342, and 344 may include a miniature representation of the content (i.e., thumbnail), a picture or graphics of the device through which the content was captured, or similar symbol. In addition to location and/or date/time of copy cache content capture, a device and/or application with which the content was captured may also be includes along with the copy cache content such that different content in the copy cache may be sorted according to any one of these items when presented to a user for selection and insertion into another document/file.

In some embodiments, content stored in the shared copy cache may be removed based on a timer to prevent unnecessary long term storage of content. In other embodiments, a size of the copy cache may be limited (based on default and/or user selection) and a first-in-first-out or similar mechanism may be employed for maintaining content in the copy cache. In further embodiments, shared copy cache content may be surfaced contextually. For example, is the user is in picture editing mode in an application, image content stored in the shared copy cache may be presented when the user selects a “paste” or similar command.

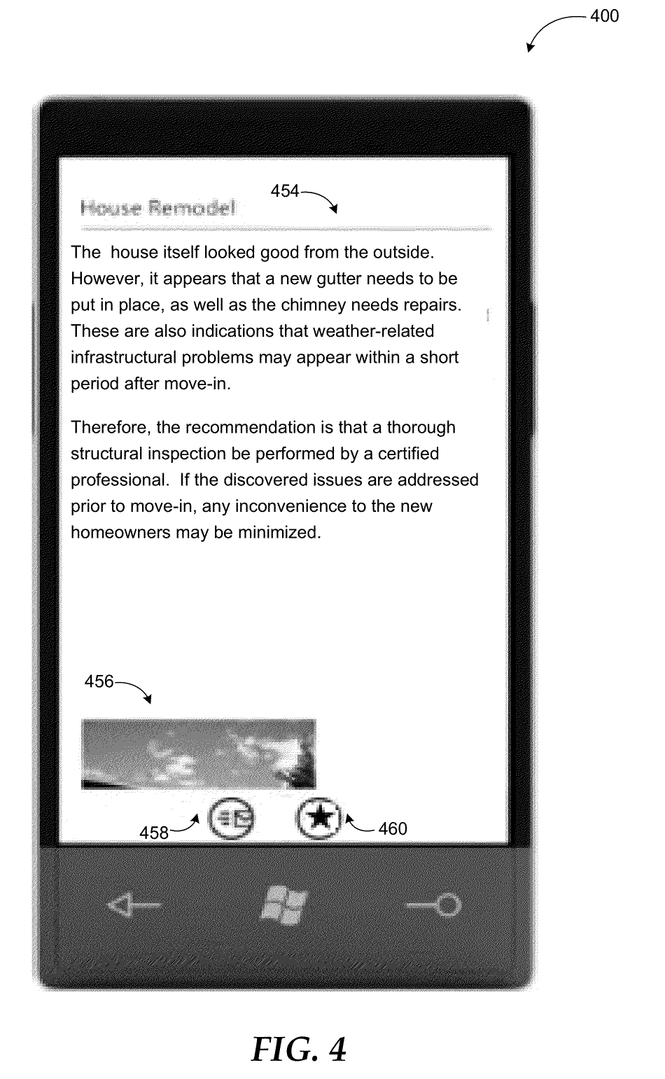

FIG. 4 illustrates another example user interface for enabling a user to add content to a shared copy cache according to embodiments. In some examples, a shared copy cache mechanism allows a user to add content to a “mobile” copy cache from any application inside a mobile device 400, for example. Any copy or “like” operation the user performs in any device, may make the stored content available to the user in another device. Content may be added to the copy cache automatically and move seamlessly to a server storage, or to another computer associated with the same user over a network.

In FIG. 4, this aspect is illustrated by the “like” command button 460, which may be used to add content such as textual content 454 or graphic content 456 to the shared copy cache. The content may also be forwarded through email or similar mechanism using the forwarding button 458.

The example embodiments in FIG. 1 through 4 are shown with specific components and configurations. Embodiments are not limited to systems according to these example configurations. Shared copy cache across different devices may be implemented in configurations employing fewer or additional components in business applications. Furthermore, the example architectures, systems and components shown in FIG. 1 through 4 and their attributes may be implemented in a similar manner with other components using the principles described herein.

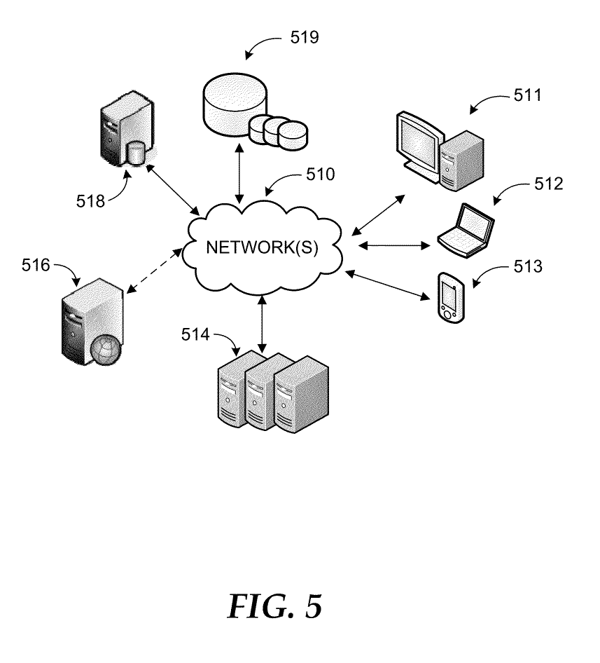

FIG. 5 is a networked environment, where a system according to embodiments may be implemented. A shared copy cache may be facilitated through an application executed over one or more servers 514 or a single server (e.g. web server) 516 such as a hosted service. The application managing the shared copy cache may communicate with applications on individual computing devices such as a smart phone 513, a laptop computer 512, or desktop computer 511 ('client devices') through network(s) 510.

As discussed above, shared copy cache can roam across a variety of devices associated with a user such as client devices 511-513, and similar devices without having to manually move information across these devices. Thus, “seamless” access to copy cache content is provided from any application on any device associated with the user.

Client devices 511-513 may enable access to copy cache content stored on remote server(s) (e.g. one of servers 514) or locally on each device as discussed previously. The server(s) may retrieve or store relevant data from/to data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a shared copy cache. Furthermore, the networked environments discussed in FIG. 5 are for illustration purposes only. Embodiments are not limited to the example applications, modules, or processes.

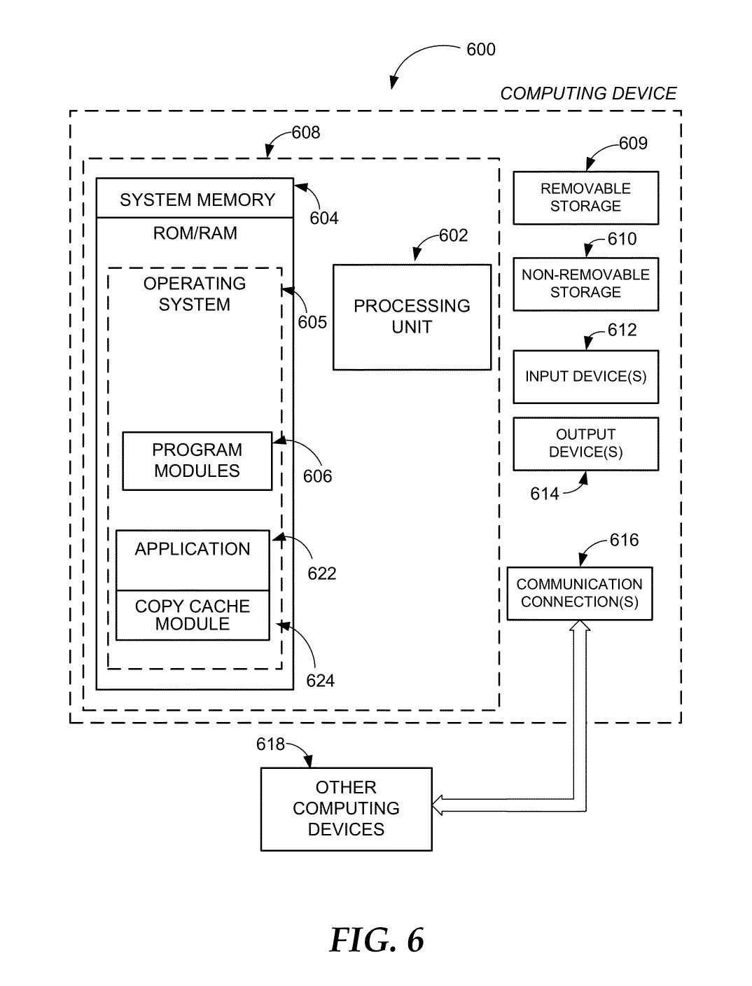

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Washington. The system memory 604 may also include one or more software applications such as program modules 606, application 622, and copy cache module 624.

Application 622 may be any application that enables creation or editing of content with access to a copy cache. The copy cache content may be stored in system memory 604, removable storage 609, non-removable storage 610, or other similar storage. Copy cache module 624 may facilitate capture of new content, sharing of newly captured content with other computing devices (and/or a server) associated with a user of computing device 600, and retrieval of stored copy cache content for use with application 622 or other applications. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. Computer readable storage media is a non-transitory computer readable memory device. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, storage servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

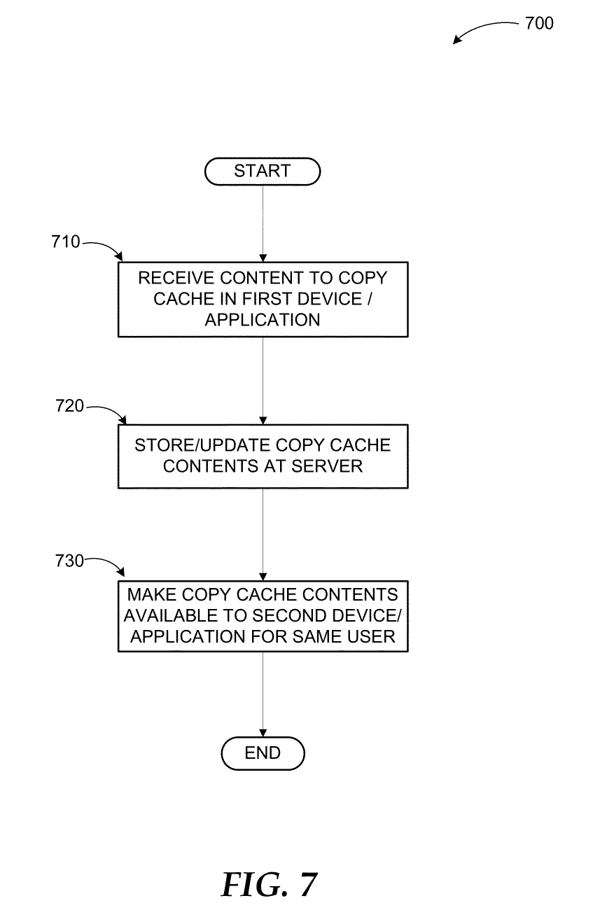

FIG. 7 illustrates a logic flow diagram for process 700 of sharing copy cache across networked devices according to embodiments. Process 700 may be implemented by any application or operating system.

Process 700 may begin with operation 710, where content is received for copy cache in a first device and application. As discussed above, this may be through automatic capture or through a user action such as a “copy” command. At operation 720, the received content may be stored in a local version of copy cache and a shared version at a server may be updated with the newly received content.

At operation 730, the shared copy cache contents including the newly added content may be made available to a second device and application associated with the same user. The shared copy cache content may be provided to any number of devices/applications over one or more networks. Content may be removed from the shared copy cache based on one or more of a predefined timer, a duration of content storage, a usage of stored content, and/or a predefined quota for the content storage.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 700 are for illustration purposes. A shared copy cache feature across networked devices may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for providing a shared copy cache, the method comprising:
receiving content for a local copy cache at a first computing device associated with a user;
storing the received content at the local copy cache;
forwarding the stored content to at least one other copy cache on another computing device; and
making the forwarded content available to one or more applications executed on a second computing device associated with the user, wherein the first computing device and the second computing device are communicatively coupled through one or more networks.

2. The method of claim 1, wherein the other computing device is a server managing the shared copy cache and making the stored content available to any computing device associated with the user including the second computing device.

3. The method of claim 1, wherein the stored content is forwarded directly to the second computing device from the first computing device.

4. The method of claim 1, further comprising:
receiving the content through one of a user action and an automatic capture.

5. The method of claim 4, wherein the automatic capture is performed based on automatic association to enable the received content from the local copy cache to be automatically added to other copy caches on other computing devices associated with the user.

6. The method of claim 1, further comprising:
presenting available content from the shared copy cache in a contextual manner through an editing user interface based on a current editing context of the user.

7. The method of claim 1, further comprising:
gathering additional information associated with the received content; and
presenting the additional information when the stored content is retrieved for use at the second computing device.

8. The method of claim 7, further comprising:
performing a backend contextual search associated with the received content at the other computing device upon receiving the forwarded content; and
including at least one search result along with the stored content in the shared copy cache.

9. The method of claim 7, wherein the additional information includes at least one from a set of: a date of capture, a time of capture, a location of capture, an application used for the capture, and a device used for the capture of the received content.

10. The method of claim 9, further comprising:
presenting available content in the shared copy cache through a user interface at the second computing device by sorting the available content based on the additional information.

11. The method of claim 1, wherein the received content includes one of: textual content, graphical content, audio content, and video content.

12. A computing device for providing a shared copy cache, the computing device comprising:
a memory storing instructions; and
a processor coupled to the memory, the processor executing an application and a copy cache control module in conjunction with the instructions stored in the memory, wherein the copy cache control module is adapted to:
receive content for a local copy cache through one of a user action and an automatic capture;
store the received content at the local copy cache;
forward the stored content to a server managing the shared copy cache, wherein the server is configured to make the content available to at least one other computing device associated with a user employing the computing device.

13. The computing device of claim 12, wherein the copy cache control module is further adapted to:
gather additional information that includes at least one from a set of: a date of capture, a time of capture, a location of capture, an application used for the capture, and a device used for the capture of the received content; and
provide the additional information to the server along with the forwarded content such that the additional information is presented along with the content from the shared copy cache on the at least one other computing device and available content from the shared copy cache is sorted based on the additional information.

14. The computing device of claim 12, wherein the copy cache control module is further adapted to:
forward the received content to the server in response to the receipt of the content at the computing device, a user action, and a periodic check by the server.

15. The computing device of claim 12, wherein the copy cache control module is further adapted to:
enable automatic addition of the received content to a respective storage at the at least one computing device based on a context of the received context.

16. The computing device of claim 12, wherein the local copy cache is maintained in one of a volatile memory and a non-volatile memory of the computing device.

17. The computing device of claim 12, wherein the computing device is one of a desktop computer, a mobile computer, a vehicle mount computer, a wearable computer, a work station, and a smart phone.

18. A computer-readable memory device with instructions stored thereon for providing a shared copy cache, the instructions comprising:
receiving content for a local copy cache at a first computing device associated with a user through one of a user action and an automatic capture;
storing the received content at the local copy cache;
forwarding the stored content to a server for managing the shared copy cache and for making the stored content available to any computing device associated with the user; and
enabling presentation of available content from the shared copy cache in a contextual manner based on a current editing context of the user at a second computing device associated with the user.

19. The computer-readable memory device of claim 18, wherein the instructions further comprise:
enabling presentation of the available content from the shared copy cache employing at least one of a textual and a graphical scheme based on one or more of: a capture time a capture date, a source location, a source device, a size, and a type of the content.

20. The computer-readable memory device of claim 18, wherein the instructions further comprise:
removing content from the shared copy cache based on one or more of: a predefined timer, a duration of content storage, a usage of stored content, and a predefined quota for the content storage.
